(19) United States
(12) Patent Application Publication
(10) Pub. No.: US 2005/0077428 A1
(43) Pub. Date: Apr. 14, 2005

(54) Push rod for a pneumatic element

(76) Inventor: Mauro Pedretti, Biasca (CH)

Correspondence Address: JENKENS & GILCHRIST, PC, 1445 ROSS AVENUE, SUITE 3200, DALLAS, TX, 75202, US

(21) Appl. No.: 10/498,589

(22) PCT Filed: Jul. 8, 2002
(86) PCT No.: PCT/CH02/00371

(30) Foreign Application Priority Data
Dec. 21, 2001 (CH) 2358/01

(51) Int. Cl. E04B 1/34; E04G 11/04; E04H 15/20; B64C 3/00; B64C 1/00; B29D 22/00

(52) U.S. Cl. 244/123; 428/36.6; 52/2.13

(57) ABSTRACT

The invention relates to a push rod (3) that absorbs pressure forces of a pneumatic element that comprises a hollow body (3) filled with a pressurized gas. Said push rod comprises a groove (8) with a substantially circular widened section (10) and a neck (9). A pocket (6) which is fastened to the hollow body (2) across its entire length can be drawn into said groove (8) before the hollow body (2) is impinged upon with the pressurized gas. After drawing, a clamping element (11) with a substantially circular cross-section is drawn into the part of the pocket (6) lying in the groove (8). Once the hollow body (2) is impinged upon with pressurized gas, the circumferential tension of the hollow body (2) extends across the clamped part of the pocket (6).

The present invention relates to a compression member, that is to say an element for absorbing the compressive forces in a pneumatic structural element, and to a device for fastening it, according to the preamble of patent claim 1.

Such compression members are known and described, for example, in European patent application 01 903 559.1 of the same inventor.

For practical considerations, the compression member in the cited document is of multi-part design, the individual parts or portions generally being pushed successively or one behind the other into suitably shaped pockets on the pneumatic structural element. Since these individual portions absorb and transmit only compressive forces, it is completely sufficient simply to line them up so that they form butt joints with one another.

The forces to be absorbed by the compression members may be considerable, however. This requires that the compressive forces be transmitted from one portion of the compression member to the other over, as far as possible, the entire cross sectional area. However, this is only the case when said pockets are manufactured very accurately and extreme care is taken when pushing in the parts or portions of the member. This in turn makes production of the pneumatic structural elements expensive and slows down construction in situ. It is also possible that, in spite of the high degree of accuracy during manufacture and care during construction, displacements of the portions relative to one another may occur over time as a result, for example, of wind-induced movements of the pneumatic structural elements, these displacements being detrimental to the quality of the structural elements. Moreover, it is fundamental for the compression members to be placed in said pockets. Attachment points for technical installations and equipment are generally associated with damage to the pockets and associated with additional expenditure.

The object of the present invention is the provision of a compression member which does not have the aforementioned disadvantages and additionally offers the possibility of providing accessible fastening points for installations and apparatus for power supplies and domestic services.

The solution to the set object is represented, in respect of its essential features, in the characterizing part of patent claim 1 and, in respect of further advantageous embodiments, in the subsequent claims.

The idea of the invention will be explained in more detail using a number of exemplary embodiments and with the aid of the attached drawings, in which

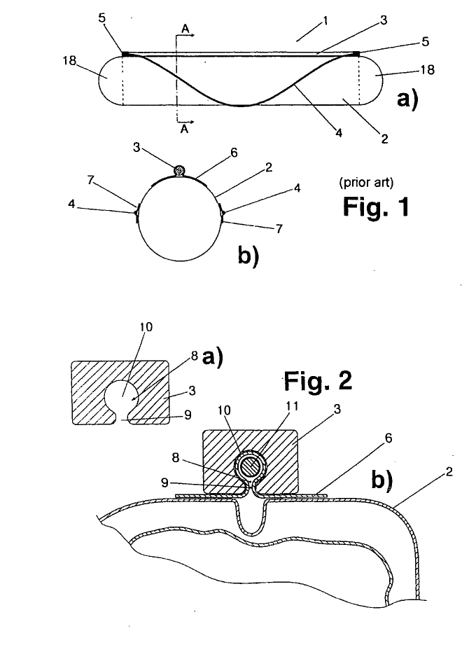

FIG. 1a shows a pneumatic structural element according to the prior art in a side view,

FIG. 1b shows the pneumatic structural element of FIG. 1a in a cross section,

FIG. 2a shows a first exemplary embodiment of a compression member in a cross section,

FIG. 2b shows a first exemplary embodiment together with a hollow body,

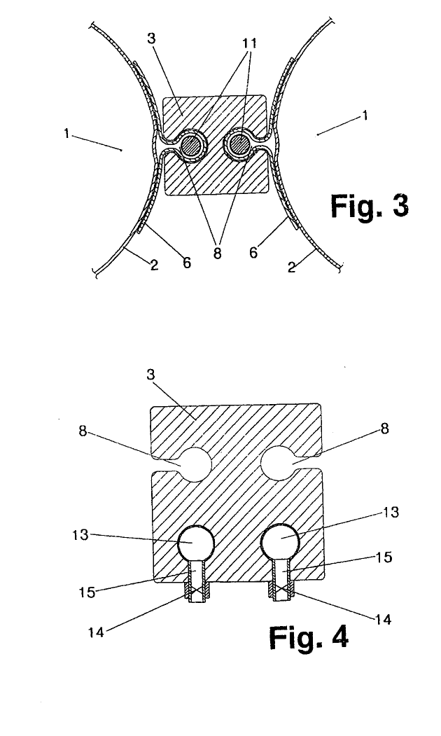

FIG. 3 shows a second exemplary embodiment of a compression member together with two hollow bodies,

FIG. 4 shows a third exemplary embodiment of a compression member in a cross section,

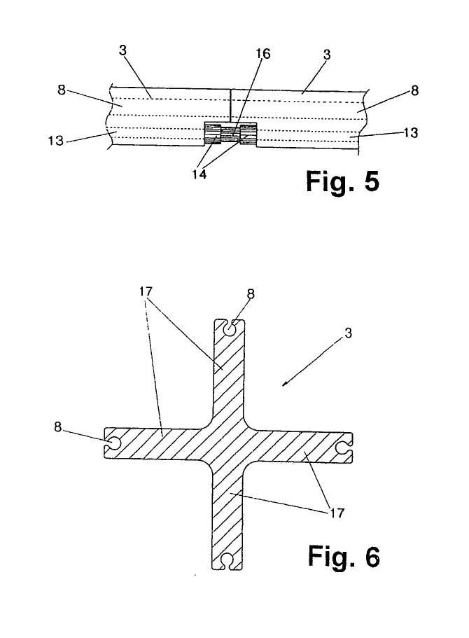

FIG. 5 shows a detail of the third exemplary embodiment in a side view,

FIG. 6 shows a fourth exemplary embodiment of a compression member in a cross section.

FIG. 1a, b relate to the prior art. FIG. 1a is a pneumatic structural element 1 in side view and comprises in this case a cylindrical hollow body 2 on which a compression member 3 is placed. At the ends of the compression member 3, this member is securely connected to two tension members 4 which are tensioned around the hollow body in opposite helical directions and abut tightly there. In the terminology of structural analysis, these fastening points of the tension members 4 are referred to as nodes 5. According to the art, the compression member 3 is pushed into pockets 6 which are fastened on the hollow body by means of welding, adhesive bonding or sewing.

The hollow body 2 has two caps 18 which close it off outwardly and preferably comprises a low-extension woven textile fabric, and is either of airtight design (for example with a PVC coating) or is only a high-tensile-strength but non-airtight sheath for an inserted flexible gas tube made of an elastic polymer material. If the hollow body 2 is intended to be airtight, the seams of the pockets 6 need to be sealed after sewing.

FIG. 1b shows a cross section AA through the pneumatic structural element 1 on a somewhat larger scale. It can also be seen here that the tension members 4 may possibly be guided within yokes 7 in order to fix their position when the structural element 1 is in the slack state.

FIGS. 2a, b now show a first exemplary embodiment of the compression member 3 according to the invention in a cross section, in FIG. 2a alone, in FIG. 2b together with the hollow body 2 to which pressurized gas has not yet been supplied. The compression member 3 has, over its entire length, a groove 8 which, in cross section, has a narrow neck 9 and an approximately circular widened portion 10. The material of the pocket 6 can be fitted into the still empty groove 8; in order to fix it therein, a clamping element 11 extending over the entire length of the compression member 3 is introduced. This may comprise a round bar made, for example, of aluminum or a polymer material, or else a round textile cord. The pocket 6 is fastened on the material of the hollow body 2 in such a way that, when the hollow body 2 is in the slack state, this material lies so loosely that the tensile stress in the sheath of the hollow body 2 runs over the material of the pocket 6 in the region of the compression member 3.

Again, there are two variants here: the sheath of the hollow body 2 is of airtight design, or a flexible gas tube 12 composed of an elastic polymer material is placed in the sheath of the hollow body.

The clamping element 11 causes the parts of the compression member 3 to be permanently aligned.

FIG. 3 depicts a second exemplary embodiment of the compression member 3 according to the invention, together with parts of the hollow body 2. The compression member 3 here is designed in such a way that it has two grooves 8 which are situated opposite one another in a mirror-inverted manner. It is possible for two pneumatic structural elements 1 according to FIG. 1 to be coupled to the compression member 3 according to FIG. 3. If, however, the pneumatic structural element 1 is designed in such a way that it has a compression member 3 along each of two generatrices offset azimuthally by 180°, each compression member being provided with two tension members 4, it is thus possible for any desired number of pneumatic components 1 to be lined up with the compression member 3 according to FIG. 3, for example in order to form a roof surface.

FIG. 4 depicts a development of the compression member 3 according to FIG. 3. The compression member 3 likewise has two grooves 8. However, its cross section is larger than that of the exemplary embodiment according to FIG. 3. Two bores 13 running along the compression member 3 are made in this enlarged cross section, for example. These are provided in order to conduct fluids, for example water and/or compressed air. The depicted cross section shows two rapid-locking mechanisms 14 which are fitted to bores 15 which are made transversely with respect to the bores 13 running longitudinally, and make it possible to supply water and compressed air to consumers which are provided under a roof as mentioned above. Of course, the stated rapid-locking mechanisms 14 are coded in such a way that they can be used only either for water or for compressed air, as corresponds to the prior art.

If a number of portions of compression members 3 are butt-jointed, then the individual portions have between them connection elements likewise based on the rapid-locking principle, as is depicted in FIG. 5 in a side view. In this case, an intermediate piece 16, for example, is arranged between the rapid-locking mechanisms 14, this piece reacting in an elastically resilient manner to longitudinal loading on the one hand and being flexible in bending on the other hand, with the result that, in terms of statics, the rapid-locking mechanisms 14 are undefined and no appreciable bending and compressive forces are dissipated via them. Of course, water and compressed air are conceived only in the sense of nonlimiting examples. More generally, reference may be made to supply lines, which are embodied by the bores 13 running longitudinally. It is also possible for the compression member 3 to carry busbars of known design, either as an alternative to or in addition to the stated bores 13. Of course, it is in this way also possible for communication and data lines to be integrated, for example via coaxial cables in the compression members 3. It is thus possible for a temporary or permanently erected building set up with the aforementioned pneumatic structural elements 1, or else for only a corresponding roof, to be equipped and provided with all the necessary supply lines without lines having to be laid.

A further exemplary embodiment of the compression member 3 according to the invention is represented schematically in FIG. 6 and is intended for connecting four pneumatic structural elements 1. In accordance with its intended use, it carries four arms 17 as seen in cross section, the described grooves 8 being arranged at the ends of these arms. Of course, it is possible for one or more arms 17 in turn to be configured and equipped so as to be able to accommodate supply lines, as stated in relation to FIG. 5.

Instead of four arms 17, the compression member 3 may, of course, also have a different number of arms 17, such as, for example, three or six. In addition, the pneumatic structural elements 1 fastened thereon may be equipped with compression members 3 according to FIG. 3 and thus connected to one another.

It is advantageous for the compression members 3 to be composed of extruded aluminum profiles since this can be carried out in a cost-effective manner on the one hand and with a high degree of design freedom on the other hand. It is also possible for the anticipated compressive forces to be harmonized with the necessary cross-sectional areas and shapes.

This in no way means that other materials such as extrudable composite polymer materials are rejected, the important thing for each application of pneumatic structural elements being to find the optimum solution in respect of purpose, design and cost.

1. A compression member for a pneumatic structural element (1) which comprises a substantially cylindrical hollow body (2) that is gastight or comprises a sealed flexible gas tube, at least one compression member (3) arranged along a generatrix of this hollow body (2) and, for each compression member (3), at least two tension members (4) which, starting from the ends of the at least one compression member (3), are tensioned around the hollow body (2) in opposite helical directions, and a device for fastening said compression member to a hollow body (2), characterized in that
the compression member (3) has over its entire length at least one groove (8) which is divided into a neck (9) and a substantially circular widened portion (10),
the hollow body (2) has a pocket (6) which extends over the entire length of said hollow body and is fastened over its entire length to the hollow body (2),
the pocket (6) can be fitted over its entire length into the groove (8),
a clamping element (11) is present with substantially the same length as the compression member (3), which clamping element can be pushed into that part of the pocket (6) that is fitted into the groove (8) and clamps this part in the groove (8) when the hollow body (2) is pressurized.

2. The compression member and device for fastening it to a hollow body (2) as claimed in patent claim 1, characterized in that the clamping element (11) is a round bar.

3. The compression member and device for fastening it to a hollow body (2) as claimed in patent claim 1, characterized in that the clamping element (11) is a round cord.

4. The compression member and device for fastening it to a hollow body (2) as claimed in patent claim 1, characterized in that the compression member (3) has two grooves (8) which are arranged in a mirror-inverted manner on the compression member (3) and can absorb the compressive forces of two pneumatic structural elements (1) and connect the latter at the same time.

5. The compression member and device for fastening it to a hollow body (2) as claimed in patent claim 1, characterized in that the compression member (3) has at least three arms (17) in cross section which extend over its entire length and have a groove (8) at each of their outer ends, which compression member (3) can thus absorb the compressive forces of just as many pneumatic structural elements (1) and connect the latter at the same time.

6. The compression member and device for fastening it to a hollow body (2) as claimed in patent claim 5, characterized in that each hollow body (2) has at least two further pockets (6) for fastening the hollow bodies (2) to compression members (3) which can connect in each case two hollow bodies (2) to one another.

7. The compression member and device for fastening it to a hollow body (2) as claimed in patent claim 4 or 5, characterized in that the compression member (3) has at least one bore (13) running longitudinally for holding and carrying fluids.

8. The compression member and device for fastening it to a hollow body (2) as claimed in patent claim 7, characterized in that the fluid is water.

9. The compression member and device for fastening it to a hollow body (2) as claimed in patent claim 7, characterized in that the fluid is a pressurized gas.

10. The compression member and device for fastening it to a hollow body (2) as claimed in patent claim 7, characterized in that the compression member (3) has a multiplicity of bores (15) which run transversely with respect to the longitudinal bores (13) and contain rapid-locking mechanisms (14) for connecting hoses to the fluid-carrying longitudinal bores (13).

11. The compression member and device for fastening it to a hollow body (2) as claimed in patent claim 7, characterized in that the longitudinal bores (13) of the individual portions of the compression member (3) are equipped at their ends with rapid-locking mechanisms (14) with a longitudinally resilient and flexible intermediate piece (16) for connecting the longitudinal bores (13) of the individual portions of the compression member (3).

12. The compression member and device for fastening it to a hollow body (2) as claimed in patent claim 4 or 5, characterized in that the compression member (3) carries busbars for supplying electrical current to consumers.

13. The compression member and device for fastening it to a hollow body (2) as claimed in patent claim 4 or 5, characterized in that the compression member (3) contains integrated coaxial cables.

14. The compression member and device for fastening it to a hollow body (2) as claimed in one of patent claims 1, 4, 5, 6, 7, characterized in that the compression member (3) comprises an extruded aluminum profile.

15. The compression member and device for fastening it to a hollow body (2) as claimed in one of patent claims 1, 4, 5, 6, 7, characterized in that the compression member (3) comprises an extruded composite material.
